(19) United States
(12) Patent Application Publication
(10) Pub. No.: US 2013/0002375 A1
(43) Pub. Date: Jan. 3, 2013

(54) TRANSMISSION LINE STRUCTURE WITH LOW CROSSTALK

(75) Inventors: Ming-Tzong Yang, Baoshan Township (TW); Tung-Hsing Lee, Lujhou City (TW); Kuei-Ti Chan, Hsinchu City (TW)

(73) Assignee: MEDIATEK INC., Hsin-Chu (TW)

(21) Appl. No.: 13/175,253

(22) Filed: Jul. 1, 2011

(51) Int. Cl. H01P 3/08

(52) U.S. Cl. 333/238; 333/243

(57) ABSTRACT

A transmission line structure is disclosed. The structure includes at least one signal transmission line and a pair of ground transmission lines embedded in a first level of a dielectric layer on a substrate, wherein the pair of ground transmission lines are on both sides of the signal transmission line. A first ground layer is embedded in a second level lower than the first level of the dielectric layer and a second ground layer is embedded in a third level higher than the first level of the dielectric layer. First and second pairs of via connectors are embedded in the dielectric layer, wherein the first pair of via connectors electrically connects the pair of ground transmission lines to the first ground layer and the second pair of via connectors electrically connects the pair of ground transmission lines to the second ground layer.

### BACKGROUND OF THE INVENTION

1. Field of the Invention

The invention relates to transmission lines in an integrated circuit (IC) and more particularly to a transmission line structure with low crosstalk.

2. Description of the Related Art

Integrated circuits use many types of microelectronic devices formed in and/or on a semiconductor substrate to carry out numerous functions. These circuits require a multitude of conductive pathways to provide communications and connectivity between the microelectronic devices. Accordingly, a complete integrated circuit produced on a surface of a substrate generally includes several superposed layers of insulating materials, each of which incorporate conductive parts, referred to as transmission lines, to interconnect with microelectronic devices.

With the increasing complexity and ongoing miniaturization of integrated circuits, the severity of dealing with electromagnetic interference (EMI) problems hag increased. When electronic devices/components have higher speeds and higher device density, noise occurs. In a good transmission line design, signal delay, distortion and crosstalk noise are minimized. Crosstalk is a noise induced primarily by the electromagnetic coupling between signal transmission lines and degrades signal quality. Crosstalk occurs by the electrical coupling (e.g., capacitive coupling and inductive coupling) between nearby signal transmission lines. As more and more functions are integrated on a semiconductor substrate, more transmission lines are needed, and thus the coupling between nearby signal transmission lines have become greater, introducing noise and false signals into systems.

Accordingly, there is a need to develop a novel transmission line structure which is capable of mitigating the aforementioned problems.

### BRIEF SUMMARY OF THE INVENTION

An exemplary embodiment of a transmission line structure comprises a dielectric layer disposed on a substrate. At least one signal transmission line is embedded in a first level of the dielectric layer. A pair of ground transmission lines is embedded in the first level of the dielectric layer and on both sides of the signal transmission line. A first ground layer is embedded in a second level lower than the first level of the dielectric layer and under the first signal transmission line and the pair of ground transmission lines. A second ground layer is embedded in a third level higher than the first level of the dielectric layer and above the first signal transmission line and the pair of ground transmission lines. A first pair of via connectors is embedded in the dielectric layer and electrically connects the pair of ground transmission lines to the first ground layer. A second pair of via connectors is embedded in the dielectric layer and electrically connects the pair of ground transmission lines to the second ground layer.

### BRIEF DESCRIPTION OF DRAWINGS

The invention can be more fully understood by reading the subsequent detailed description and examples with references made to the accompanying drawings, wherein:

FIG. 1A shows a plan view of an exemplary embodiment of a transmission line structure for an integrated circuit (IC) according to the invention;

FIG. 1B shows a cross section along line 1B-1B′ of FIG. 1A;

FIG. 2 is a plan view of the first or second ground layer shown in FIGS. 1A and 1B;

FIG. 3 is a plan view of another exemplary embodiment of a transmission line structure for an IC according to the invention;

FIG. 4 is a cross section of another exemplary embodiment of a transmission line structure for an IC according to the invention; and

FIG. 5 is a cross section of another exemplary embodiment of a transmission line structure for an IC according to the invention.

### DETAILED DESCRIPTION OF INVENTION

The following description encompasses the fabrication and the purpose of the invention. It can be understood that this description is provided for the purpose of illustrating the fabrication and the use of the invention and should not be taken in a limited sense. In the drawings or disclosure, the same or similar elements are represented or labeled by the same or similar symbols. Moreover, the shapes or thicknesses of the elements shown in the drawings may be magnified for simplicity and convenience. Additionally, the elements not shown or described in the drawings or disclosure are common elements which are well known in the art.

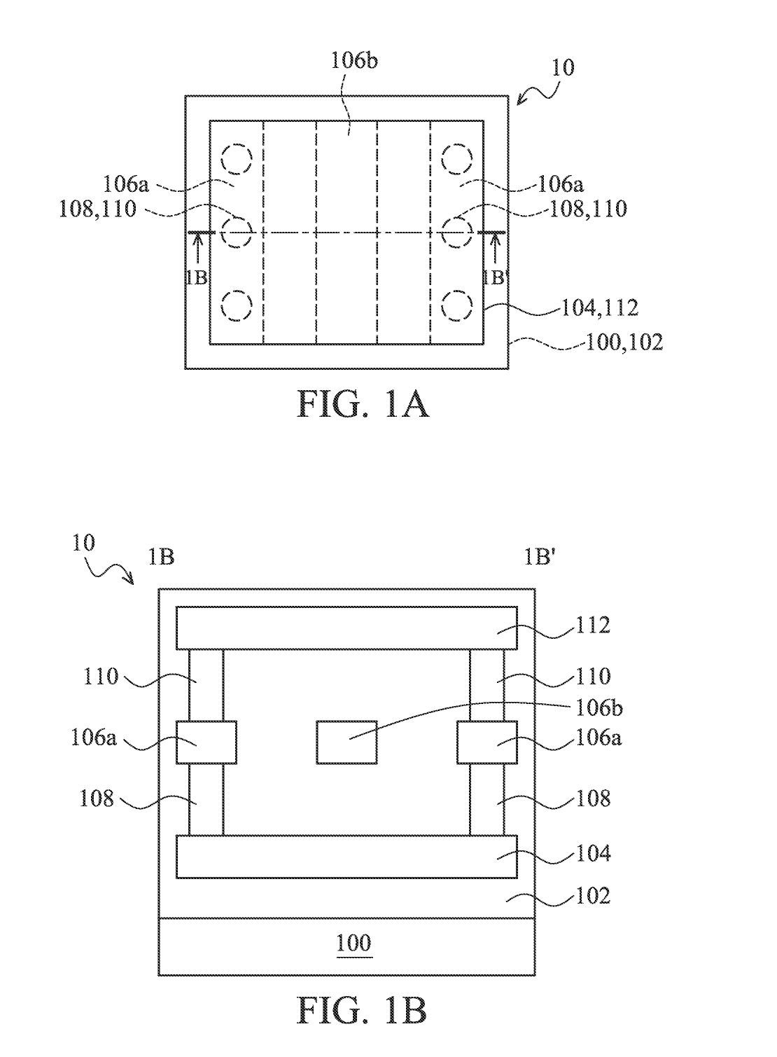

Referring to FIGS. 1A and 1B, which respectively illustrate a plan view of an exemplary embodiment of a transmission line structure 10 for an integrated circuit (IC) according to the invention and a cross section along line 1B-1B′ of FIG. 1A. In the embodiment, the transmission line structure 10 comprises a semiconductor substrate 100 and a dielectric layer 102 disposed on the front surface of the semiconductor substrate 100. Here, the “front surface” indicates an active surface. The semiconductor substrate 100 may comprises silicon substrate or other semiconductor materials. The semiconductor substrate 200 has a device region and may contain a variety of elements in the device region, including, transistors, resistors, and other semiconductor elements as known in the art. The semiconductor substrate 100 may also contain conductive layers, insulating layers or isolation structures. The conductive layers typically comprises metal, such as copper, commonly used in the semiconductor industry for wiring discrete devices in and on the semiconductor substrate 100. In order to simplify the diagram, a flat semiconductor substrate is depicted. The dielectric layer 102 may comprises an interlayer dielectric (ILD) layer and/or an overlying intermetal dielectric (IMD) layer. The dielectric layer 102 may be formed by chemical vapor deposition (CVD), low pressure chemical vapor deposition (LPCVD), plasma enhanced chemical vapor deposition (PECVD), high density plasma chemical vapor deposition (HDPCVD) or other deposition processes well known in the art and may comprise silicon oxide, silicon nitride (e.g., SiN, Si₃N₄), silicon oxynitride (e.g., SiON), silicon carbide (e.g., SiC), silicon oxycarbide (e.g., SiOC), low k material (e.g., fluorinated silicate glass (FSG), carbon doped oxide, methyl silsesquioxane (MSQ), hydrogen silsesquioxane (HSQ), or fluorine tetra-ethyl-orthosilicate (FTEOS)), or combinations thereof. Additionally, metal interconnections (not shown) may be formed in the ILD layer.

A first signal transmission line 106b is embedded in a first level of the dielectric layer 102. The first signal transmission line 106b may be employed to transmit a high frequency signal. A pair of ground transmission lines 106a is embedded in the same level as the first level of the dielectric layer 102, such that the first signal transmission line 106b is coplanar with the pair of ground transmission lines 106a. In the embodiment, the pair of ground transmission lines 106a is on both sides of the first signal transmission line 106b. The pair of ground transmission lines 106a and the first signal transmission line 106b may be formed of the same conductive layer, such as a polysilicon or metal conductive layer.

Crosstalk noise between the first signal transmission line 106b and other signal transmission lines (not shown) embedded in the same level as the first level of the dielectric layer 102 and outside of the pair of ground transmission lines 106a can be virtually suppressed by the pair of ground transmission lines 106a.

A first ground layer 104 is embedded in a second level lower than the first level of the dielectric layer 102 and substantially under the first signal transmission line 106b and the pair of ground transmission lines 106a. In the embodiment, the first level may be the next level from the second level. In another embodiment, the first level may be the next two or more levels from the second level.

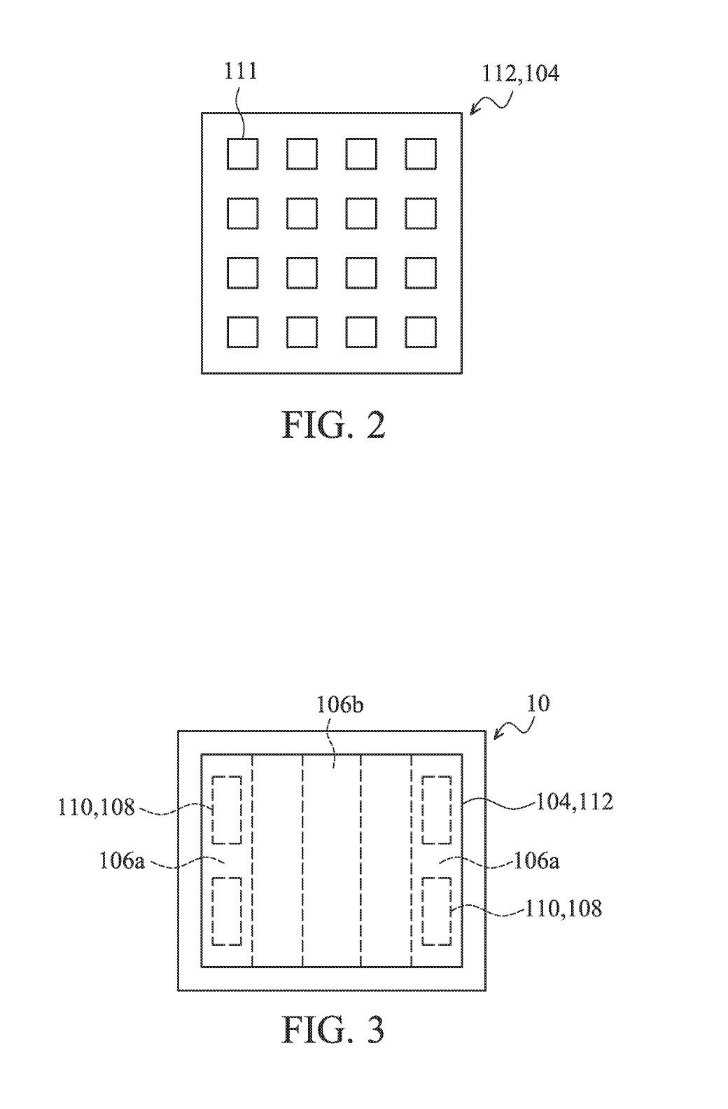

A second ground layer 112 is embedded in a third level higher than the first level of the dielectric layer 102 and substantially above the first signal transmission line 106b and the pair of ground transmission lines 106a, such that the second ground layer 112 is substantially aligned to the first ground layer 104. In the embodiment, the third level may be next level from the first level. In another embodiment, the third level may be the next two or more levels from the first level. The first ground layer 104 and/or the second ground layer 112 may comprise polysilicon or metal. In one embodiment, the first ground layer and/or the second ground layer 112 may be configured as a solid plate layer. In another embodiment, the first ground layer 104 and/or the second ground layer 112 may have at least one opening, such as a circular hole, slot or any shaped opening. Referring to FIG. 2, which illustrates a plan view of an exemplary embodiment of the first or second ground layer 104 or 112 shown in FIGS. 1A and 1B, the first ground layer 104 and/or the second ground layer 112 may have a plurality of openings 111 and be configured as a grid layer.

Referring to FIGS. 1A and 1B, at least one first pair of via connectors 108 is embedded in the dielectric layer 102 and electrically connects the pair of ground transmission lines 106a to the first ground layer 104. Note that the number of the first pair of via connectors 108 is based on design demands, although three first pairs of via connectors 108 are depicted in FIG. 1A. At least one second pair of via connectors 110 is embedded in the dielectric layer 102 and electrically connects the pair of ground transmission lines 106a to the second ground layer 112. Note that the number of the second pair of via connectors 110 is also based on the design demands, although three second pairs of via connectors 110 are depicted in FIG. 1A. In the embodiment, each of the first pair of via connectors 108 and each of the second pair of via connectors 110 may comprise at least one via-plug connector, respectively.

Alternatively, refer to FIG. 3, which illustrates a plan view of another exemplary embodiment of a transmission line structure for an IC according to the invention. Elements in FIG. 3 that are the same as those in FIG. 1A or 1B are labeled with the same reference numbers as in FIG. 1A or 1B and are not described again for brevity. Each of the first pair of via connectors 108 and each of the second pair of via connectors 110 may comprise at least one via-slot connector, respectively.

Crosstalk noise between the first signal transmission line 106b and other signal transmission lines (not shown) embedded in the different levels from the first level of the dielectric layer 102, higher than the second ground layer 112 and lower than the first ground layer 104 can be virtually suppressed by the first ground layer 104 or the second ground layer 112.

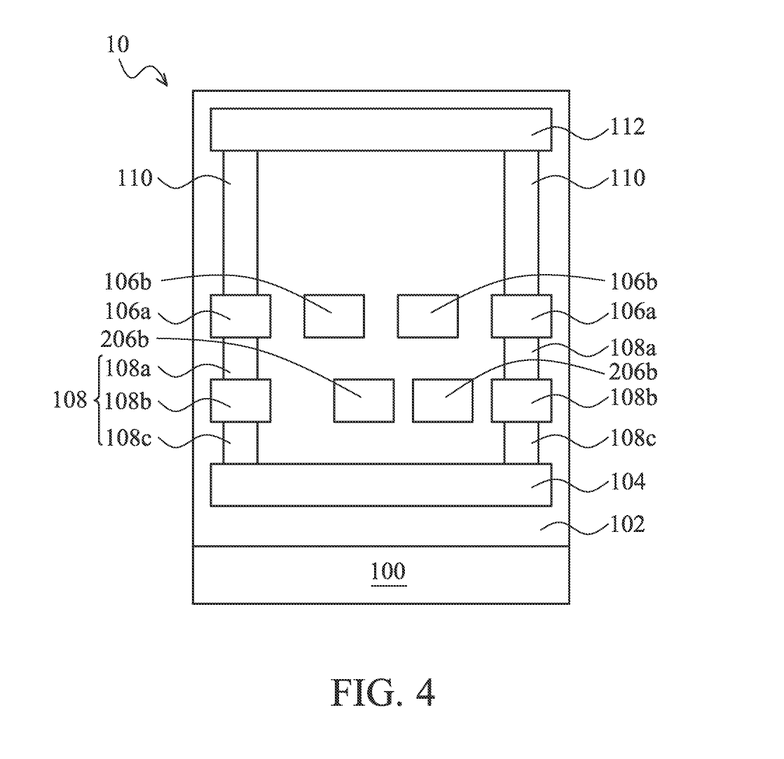

Referring to FIG. 4, which illustrates a cross section of another exemplary embodiment of a transmission line structure for an IC according to the invention. Elements in FIG. 4 that are the same as those in FIG. 1A or 1B are labeled with the same reference numbers as in FIG. 1A or 1B and are not described again for brevity. In the embodiment, a plurality of first signal transmission lines 106b is embedded in the first level of the dielectric layer 102 and between the pair of ground transmission lines 106a. In one embodiment, a second signal transmission line 206b is embedded in a level between the first and second levels of the dielectric layer 102 where the first signal transmission line 106b and the first ground layer 104 are embedded therein, respectively, such that the second signal transmission line 206b is between the first pair of via connectors 108. In another embodiment, a plurality of second signal transmission lines 206b (e.g., two second signal transmission lines 206b) are embedded in the dielectric layer 102 and between the first pair of via connectors 108. Each of the first pair of via connectors 108 may comprise at least one via-plug connectors or via-slot connector. For example, each of the first pair of via connectors 108 comprises two via-plug connectors or via-slot connectors 108a and 108c and a conductive connecting layer 108b interposed therebetween and in direct contact with the via-plug connectors or via-slot connectors 108a and 108c, wherein the conductive connecting layer 108b may be embedded in the same level of the dielectric layer 102 as that of the second signal transmission lines 206b. Note that the number of the via-plug connectors or via-slot connectors in each of the first pair of via connectors 108 is based on the design demands, even though two via-plug connectors or via-slot connectors 108a and 108c are depicted in FIG. 4.

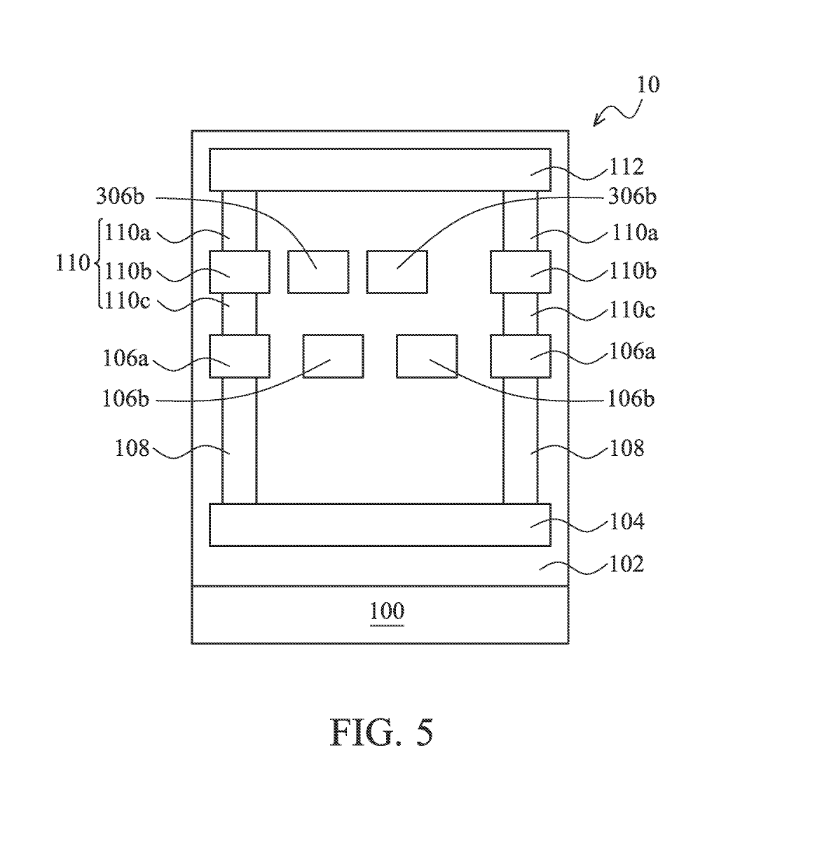

Referring to FIG. 5, which illustrates a cross section of another exemplary embodiment of a transmission line structure for an IC according to the invention. Elements in FIG. 5 that are the same as those in FIG. 1A or 1B are labeled with the same reference numbers as in FIG. 1A or 1B and are not described again for brevity. In the embodiment, a plurality of first signal transmission lines 106b is embedded in the first level of the dielectric layer 102 and between the pair of ground transmission lines 106a. In one embodiment, a third signal transmission line 306b is embedded in a level between the first and third levels of the dielectric layer 102 where the first signal transmission line 106b and the second ground layer 112 are embedded therein, respectively, such that the third signal transmission line 306b is between the second pair of via connectors 110. In another embodiment, a plurality of third signal transmission lines 306b (e.g., two third signal transmission lines 306b) are embedded in the dielectric layer 102 and between the second pair of via connectors 110. Each of the second pair of via connectors 110 may comprise at least one via-plug connector or via-slot connector. For example, each of the second pair of via connectors 110 comprises two via-plug connectors or via-slot connectors 110a and 110c and a conductive connecting layer 110b interposed therebetween and in direct contact with the via-plug connectors or via-slot connectors 110a and 110c, wherein the conductive connecting layer 110b may be embedded in the same level of the dielectric layer 102 as that of the third signal transmission lines 306b. Also, note that the number of the via-plug connectors or via-slot connectors in each of the second pair of via connectors 110 is based on the design demands, even though two via-plug connectors or via-slot connectors 110a and 110c are depicted in FIG. 5.

According to the aforementioned embodiments, crosstalk noise can be effectively suppressed by the arrangement of the pair of ground transmission lines 106a, the first ground layers and second ground layers 104 and 112, the first pair of via connectors 108 interposed between the first ground layer 104 and the pair of ground transmission lines 106a, and the second pair of via connectors 110 interposed between the second ground layer 112 and the pair of ground transmission lines 106a. Accordingly, signal quality of the transmission lines in the transmission line structure can be improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transmission line structure, comprising:
a dielectric layer disposed on a substrate;
at least one first signal transmission line embedded in a first level of the dielectric layer;
a pair of ground transmission lines embedded in the first level of the dielectric layer and on both sides of the signal transmission line;
a first ground layer embedded in a second level lower than the first level of the dielectric layer and under the first signal transmission line and the pair of ground transmission lines;
a second ground layer embedded in a third level higher than the first level of the dielectric layer and above the first signal transmission line and the pair of ground transmission lines;
a first pair of via connectors embedded in the dielectric layer and electrically connecting the pair of ground transmission lines to the first ground layer; and
a second pair of via connectors embedded in the dielectric layer and electrically connecting the pair of ground transmission lines to the second ground layer.

2. The transmission line structure of claim 1, further comprising a plurality of first signal transmission lines embedded in the first level of the dielectric layer and between the pair of ground transmission lines.

3. The transmission line structure of claim 1, further comprising at least one second signal transmission line embedded in a level between the first and second

4. The transmission line structure of claim 3, further comprising a plurality of second signal transmission lines embedded in the level between the first and second levels of the dielectric layer and between the first pair of via connectors.

5. The transmission line structure of claim 1, further comprising at least one third signal transmission line embedded in a level between the first and third levels of the dielectric layer and between the first pair of via connectors.

6. The transmission line structure of claim 5, further comprising a plurality of third signal transmission lines embedded in the level between the first and third levels of the dielectric layer and between the first pair of via connectors.

7. The transmission line structure of claim 1, wherein the first signal transmission line and the pair of ground transmission lines comprise polysilicon or metal.

8. The transmission line structure of claim 1, wherein the first ground layer comprises polysilicon or metal.

9. The transmission line structure of claim 1, wherein the second ground layer comprises polysilicon or metal.

10. The transmission line structure of claim 1, wherein the first ground layer is configured as a grid layer or a solid plate layer.

11. The transmission line structure of claim 1, wherein the first ground layer has at least one opening therein.

12. The transmission line structure of claim 1, wherein the second ground layer is configured as a grid layer or a solid plate layer.

13. The transmission line structure of claim 1, wherein the second ground

14. The transmission line structure of claim 1, wherein each of the first pair of via connectors comprises at least one via-plug connector or at least one via-slot connector.

15. The transmission line structure of claim 1, wherein each of the second pair of via connectors comprises at least one via-plug connector or comprises at least one via-slot connector.
